(19) United States
(12) Patent Application Publication
(10) Pub. No.: US 2008/0194214 A1
(43) Pub. Date: Aug. 14, 2008

(54) Transmitting-Receiving Circuit for Overlapping Transmitting and Receiving Channels

(75) Inventor: Klaus Wolfsberger, Worgl (AT)

Correspondence Address: NIXON & VANDERHYE, PC, 901 NORTH GLEBE ROAD, 11TH FLOOR, ARLINGTON, VA, 22203, US

(73) Assignee: KATHREIN-Austria Ges. m.b.H., Kufstein (AT)

(21) Appl. No.: 12/067,499

(22) PCT Filed: Sep. 28, 2006
(86) PCT No.: PCT/EP2006/009445

§ 371 Date: Apr. 11, 2008

(30) Foreign Application Priority Data
Oct. 6, 2005 (DE) 10 2005 047 973.1

(51) Int. Cl. H04B 1/56

(52) U.S. Cl. 455/78

(57) ABSTRACT

The invention relates to an improved transmitting-receiving circuit for overlapping transmitting and receiving channels comprising two 3-gate circuits (15a, 15b), wherein two transmitting paths (11a, 11b) are associated to a transmitting input (1), two receiving paths, (25a, 25b) are associated to a receiving output (3) and two antenna paths (21a, 21b) are associated to an antenna connector (5), each part leading to said two 3-gate circuits (15a, 15b). A phase shift, preferably of 90°, is carried out in one path, respectively, whereas no shift phase is carried out in the corresponding parallel path, thereby making it possible to produce a broadband suppression on the receiving output for all signal components jumping from the transmitting input (1) over to the receiving output (3).

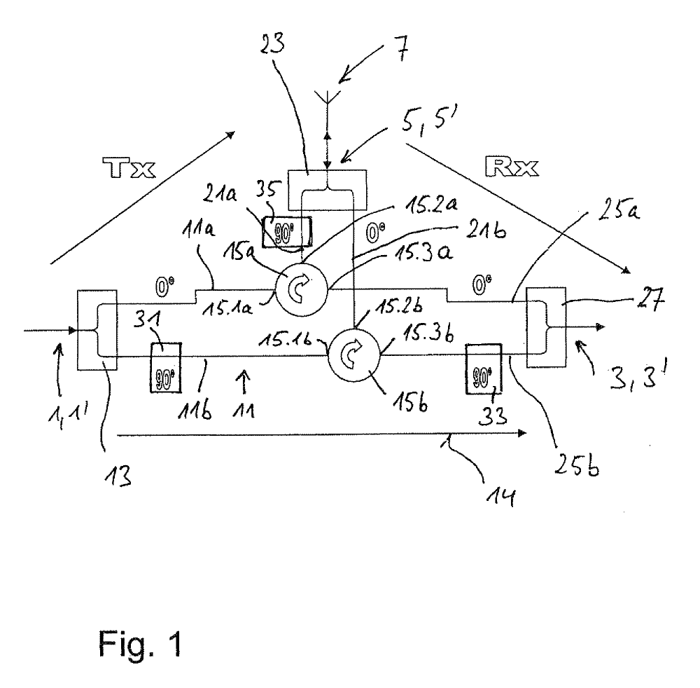

The invention relates to a transmitting-receiving circuit for overlapping transmitting and receiving channels as claimed in the preamble of claim 1.

Transmitting-receiving circuits for overlapping transmitting and receiving channels are needed for example in the area of RFID technology. As is generally known the RFID system concerns “radio frequency identification systems”. By means of this RFID technology a permanent and always up-to-date overview can be produced for example about the status or location of the most varied of articles in many areas. For example a continual check can be made in archiving systems, warehouse stocks, in department stores or warehouses etc, as to where certain goods are located or if they are still available or otherwise, etc. For this purpose so-called RFID tags are used, which in the meantime can be produced at low cost and can be referenced quickly and with high storage capacity to identify the products. Transmitting-receiving units, which operate within technical limits in the same frequency range, are used for corresponding interrogation and readout, which take place without contact.

As a result it is generally known that backscatter effects occur, which impair the efficiency of the so-called “readers”, that is to say, those products which are capable of reading and writing a variety of RFID tags.

The prior art readers in this case are designed so that they have at least three connectors or interfaces, that is to say, a transmitting input, a receiving output as well as an antenna connector. Transmission signals, which are radiated by the antenna, are sent to the transmitting-receiving circuit via the transmitting input. Vice versa, signals which are broadcast via the receiver interface of the downstream reader unit are received via the antenna.

For this purpose usually a 3-gate circuit is used, so that the signals sent via the transmitter interface are only coupled out to the antenna connector for relaying to the antenna and in reverse the signals coupled in via the antenna and received via the 3-gate circuit can only be relayed to the receiving connector. However in this case cross modulation of the outbound signals occurs to quite a large extent on the receiving branch.

Therefore already it has been proposed that a bypass line is provided in which a tuning element is inserted between the receiving branch and transmitting branch bypassing the 3-gate circuit. This tuning element should guarantee that if a relevant component of the transmission signal jumps over to the receiving branch, obliteration or suppression of these unwanted outbound signals is ensured. However this always requires tuning or adjusting to a certain frequency, wherein therefore such a technology only works optimally for a certain frequency, which thus has an extremely narrowband width.

The object of the present invention, on the basis of the generic prior art mentioned above, is to create an improved transmitting-receiving circuit for overlapping receiving and transmission signals, which works in particular on a broadband width.

The object is achieved according to the invention with the features indicated in claim 1. Advantageous embodiments of the invention are indicated in the subordinate claims.

With the present invention, substantially improved suppression of the cross modulation of the signals, sent from the transmitting input, onto the receiving branch is achieved. Also, adjustment is no longer necessary since the solution according to the invention is broadband. In other words broadband suppression, which is equally effective for different frequencies, is obtained in the context of the invention.

In addition the structure according to the invention is simpler than in the case of a retro-adjusted transmitting-receiving circuit according to the prior art.

The solution according to the invention essentially comprises a structure, wherein splitting takes place, respectively, into two line branches between the transmitting and the receiving connector. A separate circulator is placed in each line branch, so that two lines run from the two circulators to two, or via an interconnection, to one common antenna and the two further outputs of the two circulators are connected to the receiver interface via an interconnection.

The improvement according to the invention can be achieved by the fact that a 90° phase shift is effected in the one transmission branch before the gate of the 3-gate circuit and a repeat 90° phase shift of the signal is effected in the subsequent section between the output of the 3-gate circuit and the downstream receiver. A further 90° phase shift is effected between the 3-gate provided in the other branch, that is to say, the 3-gate leading to the antenna, and the downstream antenna. The consequence of this is that the outbound signals sent via the transmitter interface of the antenna on the two signal paths are again present in phase (namely with a 90° shift in both branches) and that vice versa in the case of a signal received from the antenna, after passing through both branches this signal also lies on the receiver interface with a phase shift of 90°. However, a signal jumping from the transmitting connector over to the receiving connector would undergo a 180° phase shift, that is to say, two sequential 90° phase shifts, in a branch whereas no phase shift is carried out on the other branch line leading from the transmitter to the receiver. Thus the signals, recombined on the receiver side, are present with 180° phase shift in both branches and are obliterated.

Therefore the effect according to the invention is obtained especially if the receiver-side signal is split into components with equal power rating.

Preferably the signals coupled out via the two 3-gate circuits to the antenna are sent via an interconnection of a common antenna. In addition it would be possible to send the two corresponding signals coupled out via the two 3-gate circuits to two separate antennas since also in this case radiation takes place in phase.

Further advantages, details and features of the invention will become evident from the exemplary embodiment illustrated below with reference to a FIGURE.

The appended FIGURE shows a transmitting-receiving circuit for overlapping transmitting and receiving channels, which is also briefly described as a transmitting-receiving circuit for overlapping Rx and Tx channels.

Since the transmitting-receiving circuit described is preferably to be used in the context of RFID technology, the UHF channel is a suitable frequency range. Generally the transmitting-receiving circuit according to the invention is a transceiver with overlapping Tx and Rx channels without time or code multiplexing process steps.

The circuit is designed so that it comprises a transmitting input 1, which for example is constructed in the form of an interface 1′, a transmission line 1′ or generally a port 1′ as well as a receiving output 3, which likewise again can be constructed by way of an output line 3′, an interface 3′ or generally in the form of a connector 3′ or such like.

In addition an antenna input/output 5 is provided, which likewise again can be constructed by way of an antenna line, interface or generally in the form of another connector 5′, via which the circuit is connected to an antenna 7 for receiving inbound signals Rx and for transmitting outbound signals Tx.

Thus a transmission branch Tx is realized from the transmitting input 1 to the antenna connector 5′, whereas a receiving branch Rx is realized from the antenna connector 5′ to the receiving output 3′.

The circuit is now designed in such a way that between the transmitting input 1 and the receiving output 3 the transmitting path 11 leading up to a 3-gate circuit is split into two transmitting paths 11a and 11b, specifically via a power dividing circuit 13. As a result the transmission signal is split preferably with equal power rating on both transmitting paths 11a and 11a [sic].

Both transmitting paths 11a and 11b lead to a 3-gate circuit 15a and 15b in each case.

A signal split over the two transmitting paths 11a and 11b and sent to the 3-gate circuit 15a and 15b in each case via the associated input 15.1a and 15.1b, is sent via the subsequent gate 15.2a or 15.2b to two parallel antenna paths 21a and 21b which, in the exemplary embodiment shown, combined together lead to the downstream antenna 7 via a compound circuit 23.

Finally the third outputs 153a and 15.3b, therefore the third gate 15.3a and 15.3h of the receiving paths 25a and 25b formed in such a way are connected to a subsequent compound circuit 27, via which the inbound signals are sent to a receiver by the said receiving output 5 of a common derivation.

In order to ensure improved cross-modulation suppression 14 between the transmitting input 1 and the receiving output 5, several devices are now provided to produce a phase shift.

A first phase shift device (31) which is also, for short, called a phase shifter 31 below, is provided in one of the two transmitting paths 11, in the exemplary embodiment shown for example in the transmitting path 11b. In the receiving path 25 subsequently proceeding from the same 3-gate circuit 15b, a further 90° phase shift device 33 is provided which is likewise, for short, described as a 90° phase shifter.

Finally, it is also evident from the drawing that in the first antenna path 21a, which leads to the antenna 7 from the port 15.2a of the first circulator 15a via the combiner circuit 23, likewise a further 90° phase shift device 35 is provided (likewise described, for short, as a 90° phase shifter below), whereas no phase shift is carried out in the second antenna branch 21b.

As a result the following mode of operation is carried out:

A transmission signal sent via the transmitting input 1 of the circuit in two signals with equal power rating is split into the two transmitting paths or branches 11a and 11b and in each case sent to the first gate 15.1a or 15.1b of the two 3-gate circuits 15a and 15b, in which a 90° phase shift for the outbound signals is only effected in the second transmitting path 11b.

Both components of the outbound signals, preferably of equal power rating, are sent by the respective 3-gate circuit 15a and 15b via the output 15.2a and 15.2b to the two antenna paths or branches 21a and 21b, in which also here again only one 90° phase shift takes place for the signal transmitted in the one antenna path 21a, thus in that antenna path, where no phase shift was carried out in the preceding transmitting path.

Thus both transmission signal components on both branches between the transmitting input 1 (interface 1′) and the downstream antenna 7 (interface S′) undergo a 90° phase shift, thus again lie on the antenna 7 in phase.

A signal received via the antenna 7 in a reverse way coming from the antenna 7 via the bypass circuit 23 is split onto the two antenna paths 21a and 21b, preferably likewise again into two signals with the same or approximately the same power. A 90° phase shift only takes place in the first antenna path 21a (the path between the antenna 7 and the downstream gates 15.2a and 15.2b of the two 3-gate circuits 15a and 15b). A 90° phase shift is likewise carried out between the outputs 15.3a and 15.3b and the receiver-side compound circuit 27 only in the one receiving branch 25b, specifically only in that branch, where no phase shift was carried out in the preceding antenna branch. Thus again both components of the split signals received by the antenna are present in phase on the output of the compound circuit 27, that is to say, with a 90° phase shift so that they can be combined, problem-free, and associated to a downstream receiver.

However, if only the receiving and transmitting branch along the suppression path 14 and the conditions relating to unwanted jumping of a transmission signal over to the receiving branch are now observed, it can be stated that the signal split at the transmitting input 1 does not undergo any phase shift the entire way on the first signal path 11a to the first gate 15.1a of the first circulators 15a and from the third gate 15.3a of this circulator 15a to the following compound circuit 27, whereas the signal, split from the transmitting input 1 into the other branch 11b, undergoes a first 90° phase shift on the first path up to the 3-gate circuit 15b and undergoes a repeated second 90° phase shift on the path between the output 15.3b and the following compound circuit 23, that is to say, a total phase shift of 180° is carried out. Thus a signal sent on the transmission side is present on the output of the two branches, that is to say, in the compound circuit 27 with 180° phase shift so that if a signal with equal power rating is split, the signal is obliterated here.

As a result of this structure, cross modulation suppression, substantially improved in relation to the prior art, is achieved by simple means.

The phase shift devices 31, 33 and 35 mentioned can be implemented as separate and discrete components provided in the individual branches. Within the scope of the invention, however, the use of 3 dB hybrids is preferable, namely as a power dividing circuit 13, as a compound circuit 27 as well as a so-called combiner circuit 23 for splitting an inbound antenna signal as well as for combining a transmission signal sent to the antenna 7.

In the exemplary embodiment shown the middle gates 15.2a and 15.2b are combined via a combiner circuit 22 and connected to a common antenna 7.

Deviating therefrom both antenna paths 21a and 21b can also be connected to two separate antennas 7, via which they send or receive jointly, so that a combiner circuit 23 can be dispensed with in this case.

From the description of the circuit it is clear that the best result is obtained if the signals are split with equal power rating at the transmitting input 1 and the inbound signals are combined with equal power rating at the receiving output 5. In the case of the so-called combiner circuit 23 which leads to the antenna 7, likewise preferably the antenna signal is combined or split with equal power rating. The advantages according to the invention, however, can still be achieved, at least to a sufficient extent, even if the power ratings of the split signals in each case do not differ by more than 60%, in particular less than 50%, 40%, 30%, 20% and in particular less than 10%.

The exemplary embodiment according to the invention has been described for the case where on the one hand a phase shift 90° is carried out in the respective paths concerned and where no phase shift is carried out in the respective other parallel paths (that is to say, a phase shift of 0°). Suppression of a jump from the transmitting branch to the receiving branch can be produced even though a phase shift of 90°+n×180° is carried out in the respective branches concerned and in addition a phase shift of n×180° is carried out in the respective second parallel branches, in which n is either 0, 1, 2, 3 etc.

Finally it is also mentioned that a 3-gate circuit was used as a circulator. In principle, however, an n-gate circuit could also be used in which, corresponding to the mode of operation described, essentially only three gates are necessary and important.

1-9. (canceled)

10. A transmitting-receiving circuit for overlapping, receiving and transmitting channels, comprising the following features:
with a transmitting input,
with a receiving output,
with an antenna connector,
with a 3-gate circuit,
the transmitting input being connected to a first gate of the 3-gate circuit and a next gate of this 3-gate circuit connected to an antenna and the third gate of the 3-gate circuit connected to the receiving output,
two parallel split transmitting paths are arranged downstream to the transmitting input,
a second 3-gate circuit is provided, in which the respective first gate of the two 3-gate circuits in each case is connected to one transmitting path of the two transmitting paths,
two parallel antenna paths lead from the two subsequent gates of the two 3-gate circuits to the one antenna or to two antennas,
parallel receiving paths proceed from the two 3-gate circuits in each case from a third gate to the receiving output,
a device is provided in only one of the transmitting paths, in only one of the antenna paths and in only one of the receiving paths in each case for carrying out a first phase shift of 900+n×180°, in which a second phase shift of n×180° is provided in the respective other transmitting path, in the other antenna path and in the other receiving path,
the first phase shift of 90°+n×180° is provided in the transmitting path and in the receiving path, which are connected via the same 3-gate circuit,
the phase shift of 90°+n×180° is provided in that antenna path, which is connected via the 3-gate circuit to that transmitting path and to that subsequent receiving path in which a phase shift of n×180° is provided, and
in which n is a natural whole number including “0”, characterized by the following further features:
the 3-gate circuits are constructed in the form of circulators,
devices, integrated in the power dividing circuit and/or in the compound circuit and/or in the compound circuit and/or in the combiner circuit, are provided for carrying out a phase shift, and
the power dividing circuit, the combiner circuit and/or the compound circuit is/are formed as 90° hybrid integrated circuits, as a result of which a 90° phase shift is carried out in the one transmission branch, the one antenna branch and the one receiving branch respectively.

11. The transmitting-receiving circuit as claimed in claim 10, wherein two antennas are provided, in which the one antenna [sic] is connected to the one antenna path and the second antenna to the second antenna path.

12. The transmitting-receiving circuit as claimed in claim 10, wherein an antenna is provided, and wherein the two antenna paths are connected via a combiner circuit to this antenna.

13. The transmitting-receiving circuit as claimed claim 10, wherein a power dividing circuit is provided on the transmitting input, via which a sent transmission signal can be split into two signals with equal power rating or approximately equal power rating.

14. The transmitting-receiving circuit as claimed in claim 10, wherein a compound circuit is provided on the receiving output, via which the signals sent to the two receiving paths can be combined.

15. The transmitting-receiving circuit as claimed in claim 10, wherein the power dividing circuit, the combiner circuit and/or the compound circuit are formed so that the signal power or signal intensity in the respective two transmitting paths and/or the two antenna paths and/or the two receiving paths differ by less than 50%, in particular less than 40%, 30%, 20% and preferably less than 10%.
